(19) United States
(12) Patent Application Publication
(10) Pub. No.: US 2011/0039735 A1
(43) Pub. Date: Feb. 17, 2011

(54) PROBE DESIGN FOR OLIGONUCLEOTIDE FLUORESCENCE IN SITU HYBRIDIZATION (FISH)

(75) Inventors: N. ALICE YAMADA, San Jose, CO (US); PETER TSANG, San Franciscon, CO (US)

Correspondence Address: Agilent Technologies, Inc. in care of:;CPA Global, P. O. Box 52050, Minneapolis, MN, 55402, US

(73) Assignee: AGILENT TECHNOLOGIES, INC.

(21) Appl. No.: 12/541,008

(22) Filed: Aug. 13, 2009

(51) Int. Cl. C40B 50/02; C40B 50/00; C40B 60/14

(52) U.S. Cl. 506/24; 506/23; 506/40

(57) ABSTRACT

A method and a system for selecting a set of FISH probe oligonucleotide sequences from a plurality of overlapping tiled candidate FISH probe oligonucleotide sequences are provided. A composition that includes FISH probes with sequences from the set of FISH probe oligonucleotide sequences is also provided.

### BACKGROUND

Chromosomal rearrangements, deletions, and other aberrations have long been associated with genetic diseases. Structural abnormalities in chromosomes often arise from errors in homologous recombination. Aneuploidy also referred to as numerical abnormality, in which the chromosome content of a cell is abnormal, may occur as a result of nondisjunction of chromosomes during meiosis. Trisomies, in which three copies of a chromosome are present instead of the usual two, are seen in Edwards, Patau and Down syndromes. Structural abnormalities and aneuploidy can occur in gametes and therefore will be present in all cells of an affected person's body, or they can occur during mitosis and give rise to a genetic mosaic individual who has some normal and some abnormal cells.

Genomic instability also leads to complex patterns of chromosomal rearrangements in certain cells, such as cancer cells, for example. Standard cytogenetic assays such as Giemsa (G) banding have identified numerous cancer-specific translocations and chromosomal abnormalities in cancer cells such as the Philadelphia (t9, 22) chromosome. Down syndrome (a trisomy), Jacobsen syndrome (a deletion) and Burkitt's lymphoma (a translocation) have traditionally been studied via karyotype analysis.

Improvements in cytogenetic banding and visualization such as M banding and spectral karyotyping (SKY) have enabled detailed analyses on a chromosome by chromosome basis of inversions and translocations, as well as the identification of unbalanced gain or loss of chromosomal material in cancers of interest. Fluorescence in situ hybridization (FISH) further allows for the detection of the presence or absence of specific DNA sequences on chromosomes by using fluorescent probes that bind to only those parts of the chromosome with which they show a high degree of complementarity. All of these methods, however, have limited resolution since probes are generated from large pieces of DNA (flow-sorted chromosomes or bacterial artificial chromosomes for SKY and FISH, respectively). Because these probes are generated over very large regions of the genome, microtranslocations and microinversions cannot be resolved by current methods. The large templates from which probes are generated also present another disadvantage, in that both SKY and FISH probes contain repetitive DNA elements that are inherent in the large template DNA fragments. Thus, there has been an increasing need to understand more subtle chromosomal defects with substantially improved resolution, and without a priori knowledge of their location. A large unmet need exists to develop technical methods that detect novel, specific chromosomal abnormalities.

### SUMMARY

A method and system for selecting a set of FISH probe oligonucleotide sequences from a plurality of overlapping tiled candidate FISH probe oligonucleotide sequences are provided. In some embodiments, method includes: (a) providing a plurality of overlapping tiled candidate fluorescence in situ hybridization (FISH) probe oligonucleotide sequences, wherein the overlapping tiled candidate FISH probe oligonucleotide sequences are complementary to non-repeat sequences of a genome of interest and are preselected based on at least one probe property; (b) sorting the plurality of overlapping tiled candidate FISH probe oligonucleotide sequences from smallest genomic distance to largest genomic distance between neighboring overlapping tiled candidate FISH probe oligonucleotide sequences to produce a sorted plurality of tiled candidate FISH probe oligonucleotide sequences; (c) evaluating a probe property value for a neighboring pair of overlapping tiled candidate FISH probe oligonucleotide sequences from the sorted plurality to identify a first member of the neighboring pair with a more desirable probe property value than a second pair member of the neighboring pair; (d) removing the second pair member from the plurality; (e) reiterating the sorting, evaluating and removing steps at least once to produce the set of FISH probe oligonucleotide sequences; and (f) outputting the set of FISH probe oligonucleotide sequences.

In some embodiments, the probe property value is determined using a computer. In certain embodiments, the probe property may be selected from the group consisting of duplex melting temperature, hairpin stability, GC content, probe complementary to an exon, probe complementary to a gene, probe complementary to intron, probe complementary to multiple regions in the genome and a proximity score. In certain embodiments, the probe property value comprises GC content and the first member has a higher GC content than the second member. In some embodiment, the neighboring pair evaluated in step (c) is a pair that is closest to each other in terms of genomic distance in the sorted plurality. The plurality of tiled candidate FISH probe oligonucleotide sequences may have GC content in the range of 30% to 70%. In certain embodiments, the plurality of tiled candidate FISH probe oligonucleotide sequences are at least 100 nucleotides long.

In some embodiments, the method may further include producing a set of FISH probe oligonucleotides that includes the set of FISH probe oligonucleotide sequences and assaying the set of FISH probe oligonucleotide, where the assaying includes: (a) labeling the set of FISH probe oligonucleotides to produce a set of labeled FISH probe oligonucleotides and (b) hybridizing the set of labeled FISH probe oligonucleotides to an intact chromosome. In certain embodiments, the method may further include fabricating an array that comprises a set of FISH probe oligonucleotides that include the set of FISH probe oligonucleotide sequences and may further include assaying the FISH probe oligonucleotides, where the assaying includes: (a) labeling the set of FISH probe oligonucleotides to produce a set of labeled FISH probe oligonucleotides and (b) hybridizing the set of labeled FISH probe oligonucleotides to an intact chromosome.

In some embodiments, the plurality of overlapping tiled candidate FISH probe oligonucleotide sequences may include more than one hundred million candidate FISH probe oligonucleotide sequences. In some embodiments, the set of FISH probe oligonucleotide sequences may include more than ten million FISH probe oligonucleotide sequences. In some embodiments, the set of FISH probe oligonucleotide sequences may include more than half a million FISH probe oligonucleotide sequences.

Also provided is a computer readable storage medium carrying one or more sequences of instructions, wherein execution of one or more sequences of instructions by one or more processors causes the one or more processors to perform the steps of the foregoing method.

An embodiment of the system includes: (a) a communication module that includes an input manager for receiving a FISH probe request from a user and an output manager for communicating FISH probe oligonucleotide sequences to a user; (b) processing module comprising one or more sequences of instructions configured to perform the method steps described above. A method for using the system is also provided. An aspect of this method includes inputting a request for FISH probe nucleic acids for a genomic region of interest into the system and receiving from the system a subset of the plurality that has been selected in response to, e.g., to match, the request.

### BRIEF DESCRIPTION OF THE FIGURES

FIGS. 1A and 1B depict signal produced by FISH probes generated by a method described herein and compared to the signal from end-to-end tiled (regularly tiled) probes.

FIGS. 2A and 2B depict signal produced by FISH probes generated by a method described herein hybridized to chromosome X.

FIG. 3 depicts comparison between FISH probes generated from the method described herein and end-to-end tiled probes.

### DEFINITIONS

The term “nucleic acid” and “polynucleotide” are used interchangeably herein to describe a polymer of any length composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The term “complementary” as used herein refers to a nucleotide sequence that base-pairs by non-covalent bonds to a target nucleic acid of interest. In the canonical Watson-Crick base pairing, adenine (A) forms a base pair with thymine (T), as does guanine (G) with cytosine (C) in DNA. In RNA, thymine is replaced by uracil (U). As such, A is complementary to T and G is complementary to C. Typically, “complementary” refers to a nucleotide sequence that is fully complementary to a target of interest such that every nucleotide in the sequence is complementary to every nucleotide in the target nucleic acid in the corresponding positions. When a nucleotide sequence is not fully complementary (100% complementary) to a non-target sequence but still may base pair to the non-target sequence due to complementarity of certain stretches of nucleotide sequence to the non-target sequence, percent complementarily may be calculated to assess the possibility of a non-specific (off-target) binding. In general, a complementary of 50% or less does not lead to non-specific binding. In addition, a complementary of 70% or less may not lead to non-specific binding under stringent hybridization conditions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 50 to 200 nucleotides and up to 300 nucleotides in length, or longer, e.g., up to 500 nt in length or longer. Oligonucleotides may be synthetic and, in certain embodiments, are less than 300 nucleotides in length.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include poly-deoxyribonucleotides (DNA), poly-ribonucleotides (RNA), other nucleic acids that are C-glycosides of a purine or pyrimidine base, polypeptides (proteins), polysaccharides (starches, or polysugars), and other chemical entities that contain repeating units of like chemical structure.

The term “sample” as used herein relates to a material or mixture of materials, typically, although not necessarily, in fluid form, containing one or more components of interest.

The term “genomic sample” as used herein relates to a material or mixture of materials, containing genetic material from an organism. The term “genomic DNA” as used herein refers to deoxyribonucleic acids that are obtained from an organism. The terms “genomic sample” and “genomic DNA” encompass genetic material that may have undergone purification, fragmentation, or amplification.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The phrase “labeled probes” refers to mixture of nucleic acids that are detectably labeled, e.g., fluorescently labeled, such that the presence of the probe, as well as, any target sequence to which the probe is bound can be detected by assessing the presence of the label.

The phrase “surface-bound polynucleotide” refers to a polynucleotide that is immobilized on a surface of a solid substrate, where the substrate can have a variety of configurations, e.g., a sheet, bead, or other structure. In certain embodiments, the collections of polynucleotide probe elements employed herein are present on a surface of the same planar support, e.g., in the form of an array.

The term “array” encompasses the term “microarray” and refers to an ordered array presented for binding to nucleic acids and the like.

An “array,” includes any two-dimensional or substantially two-dimensional (as well as a three-dimensional) arrangement of spatially or optically addressable regions bearing nucleic acids, particularly oligonucleotides or synthetic mimetics thereof, and the like. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a front surface of the substrate. Depending upon the use, any or all of the arrays may be the same or different from one another and each may contain multiple spots or features. A typical array may contain one or more, including more than two, more than ten, more than one hundred, more than one thousand, more than ten thousand features, or even more than one hundred thousand features, in an area of less than 20 cm² or even less than 10 cm², e.g., less than about 5 cm², including less than about 1 cm², less than about 1 mm², e.g., 100 μ², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse-jets of either nucleic acid precursor units (such as monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

An array is “addressable” when it has multiple regions of different moieties (e.g., different oligonucleotide sequences) such that a region (i.e., a “feature” or “spot” of the array) at a particular predetermined location (i.e., an “address”) on the array will detect a particular sequence. Array features are typically, but need not be, separated by intervening spaces. In the case of an array in the context of the present application, the “population of labeled nucleic acids” will be referenced as a moiety in a mobile phase (typically fluid), to be detected by “surface-bound polynucleotides” which are bound to the substrate at the various regions. These phrases are synonymous with the terms “target” and “probe”, or “probe” and “target”, respectively, as they are used in other publications.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

The term “communicating” information refers to transmitting the data representing that information as signals (e.g., electrical, optical, radio signals, etc.) over a suitable communication channel (e.g., a private or public network).

The term “forwarding” an item refers to any means of getting that item from one location to the next, whether by physically transporting that item or otherwise (where that is possible) and includes, at least in the case of data, physically transporting a medium carrying the data or communicating the data.

The term “stringent assay conditions” as used herein refers to conditions that are compatible to produce binding pairs of nucleic acids, e.g., probes and targets, of sufficient complementarity to provide for the desired level of specificity in the assay while being incompatible to the formation of binding pairs between binding members of insufficient complementarity to provide for the desired specificity. Stringent assay conditions are the summation or combination (totality) of both hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1 M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions determines whether a nucleic acid is specifically hybridized to a probe. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C. In instances wherein the nucleic acid molecules are deoxyoligonucleotides (“oligos”), stringent conditions can include washing in 6×SSC/0.05% sodium pyrophosphate at 37° C. (for 14-base oligos), 48° C. (for 17-base oligos), 55° C. (for 20-base oligos), and 60° C. (for 23-base oligos). See Sambrook, Ausubel, or Tijssen (cited below) for detailed descriptions of equivalent hybridization and wash conditions and for reagents and buffers, e.g., SSC buffers and equivalent reagents and conditions.

Stringent hybridization conditions may also include a “prehybridization” of aqueous phase nucleic acids with complexity-reducing nucleic acids to suppress repetitive sequences. For example, certain stringent hybridization conditions include, prior to any hybridization to surface-bound polynucleotides, hybridization with Cot-1 DNA, or the like.

The term “probe” refers to a polynucleotide which can specifically hybridize to a target polynucleotide, either in solution or as a surface-bound polynucleotide.

The term “preselected probe” means a probe that has been passed by at least one screening or filtering process. This screening or filtering process may use experimental data related to the performance of the probes or non-empirical methods as part of the selection criteria.

The term “in silico” refers to those parameters that can be determined without the need to perform any experiments, by using information either calculated de novo or available from public or private databases.

The term “empirical” refers to experimental protocols that include a physical transformation of matter, such as hybridization assays in which an array is contacted with a sample.

The term “hybridization” refers to the specific binding of a nucleic acid to a complementary nucleic acid via Watson-Crick base pairing. Accordingly, the term “in situ hybridization” refers to specific binding of a nucleic acid to a metaphase or interphase chromosome.

The terms “hybridizing” and “binding”, with respect to nucleic acids, are used interchangeably.

The terms “plurality”, “set” or “population” are used interchangeably to mean at least 2, at least 10, at least 100, at least 500, at least 1000, at least 10,000, at least 100,000, at least 1000,000, at least 10,000,000, at least 100,000,000, or more.

The term “chromosomal region” as used herein denotes a contiguous length of nucleotides in a genome of an organism. A chromosomal region may be in the range of 10 kb in length to an entire chromosome, e.g., 100 kb to 10 MB for example.

The term “intact chromosome” refers to a chromosome that contains a centromere, a long arm containing a telomere and a short arm containing a telomere.

The term “in situ hybridization” refers to hybridization of a probe or oligonucleotide that is complementary to specific nucleic acid sequence present in an intact chromosome, where the intact chromosome may be present inside a cell or is isolated from a cell.

The term “in situ hybridization conditions” as used herein refers to conditions that allow hybridization of a nucleic acid to a complementary nucleic acid in an intact chromosome. Suitable in situ hybridization conditions may include both hybridization conditions and optional wash conditions, which include temperature, concentration of denaturing reagents, salts, incubation time, etc. Such conditions are known in the art.

A “banding pattern” refers to the pattern of banding of a set of labeled probes to an intact chromosome.

The term “genome” refers to all nucleic acid sequences (coding and non-coding) and elements present in or originating from any prokaryotic or eukaryotic organism. The term genome also applies to any naturally occurring or induced variation of these sequences that may be present in a mutant or disease variant of any cell type. For example, the human genome consists of approximately 3×10⁹ base pairs of DNA organized into distinct chromosomes. The genome of a normal diploid somatic human cell consists of 22 pairs of autosomes (chromosomes 1 to 22) and either chromosomes X and Y (males) or a pair of chromosome Xs (female) for a total of 46 chromosomes. A genome of a cancer cell may contain variable numbers of each chromosome in addition to deletions, rearrangements and amplification of any subchromosomal region or DNA sequence.

By “genomic source” is meant the initial nucleic acids that are used as the original nucleic acid source from which the solution phase nucleic acids are produced. The genomic source may be prepared using any convenient protocol. In many embodiments, the genomic source is prepared by first obtaining a starting composition of genomic DNA, e.g., a nuclear fraction of a cell lysate, where any convenient means for obtaining such a fraction may be employed and numerous protocols for doing so are well known in the art. The genomic source is, in many embodiments of interest, genomic DNA representing the entire genome from a particular organism, tissue or cell type. However, in certain embodiments, the genomic source may comprise a portion of the genome, e.g., one or more specific chromosomes or regions thereof, such as PCR amplified regions produced with a pairs of specific primers. A given initial genomic source may be prepared from a subject, for example a plant or an animal, which subject is suspected of being homozygous or heterozygous for a deletion or amplification of a genomic region.

In certain embodiments, the genomic source is “mammalian”, where this term is used broadly to describe organisms which are within the class mammalia, including the orders carnivore (e.g., dogs and cats), rodentia (e.g., mice, guinea pigs, and rats), and primates (e.g., humans, chimpanzees, and monkeys), where of particular interest in certain embodiments are human or mouse genomic sources. In certain embodiments, a set of nucleic acid sequences within the genomic source is complex, as the genome contains at least about 1×10⁸ base pairs, including at least about 1×10⁹ base pairs, e.g., about 3×10⁹ base pairs.

The term “chromosomal rearrangement,” as used herein, refers to an event where one or more parts of a chromosome are rearranged within a single chromosome or between chromosomes. In certain cases, a chromosomal rearrangement may reflect an abnormality in chromosome structure. A chromosomal rearrangement may be an inversion, a deletion, an insertion or a translocation, for example.

The term “primer” as used herein refers to an oligonucleotide that has a nucleotide sequence that is complementary to a region of a nucleic acid to be amplified. A primer binds to the complementary region and is extended, using the target nucleic acid as the template, under primer extension conditions. A primer may be in the range of about 15 to about 60 nucleotides although primers outside of this length are envisioned.

The phrase “genomic distance” means the number of nucleotide bases separating the two probe positions on the chromosome sequence of interest. The probe position may be determined in terms of the 5′ most nucleotide of a probe and the genomic distance is the number of nucleotide bases separating the 5′ most nucleotide of the two probes.

The phrase “candidate FISH probe oligonucleotide sequence” refers to a sequence of nucleotide residues that has been identified as potential nucleic acid sequence that may be present in a physical FISH probe nucleic acid (e.g., where the sequence is the sequence of the entire physical FISH probe or a portion thereof, e.g., 50% or more, such as 75% or more including 90% or more in terms of residue number) that could be used in an in situ hybridization assay, such as a FISH assay. Unless stated otherwise, candidate FISH probe oligonucleotide sequences are overlapping sequences tiled across a region of genome of interest.

The phrase “FISH probe” refers to a physical probe with a nucleic acid sequence of a FISH probe oligonucleotide sequence selected from candidate FISH probe oligonucleotide sequences for use in in situ hybridization, for example, in FISH. Although these probes are called FISH probes, they are not necessarily labeled fluorescently, and may be labeled with non-fluorescent labels, for example, with chromogenic labels.

The phrase “tiled probes” refers to overlapping and non-overlapping probes that are designed to span or “tile” across genomic regions of interest. Non-overlapping tiled probes may be end-to-end tiled with no bases separating them or they may be spaced farther apart.

### DETAILED DESCRIPTION

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Method for Selecting FISH Probes

As summarized above, a method for selecting FISH probes from a plurality of overlapping tiled candidate FISH probe oligonucleotide sequences for a genomic region of interest is provided. In certain embodiments, the method includes providing a plurality of overlapping tiled candidate FISH probe nucleic acid sequences for a genomic region of interest. The plurality of overlapping tiled candidate FISH probe nucleic acid sequences are identified from the non-repeat sequences of a genome of interest and preselected based on at least one probe property. For example, as will be described in detail below, the probe property may be sequence specificity. Thus, in some embodiments, each probe of the plurality of candidate FISH probes is complementary to a single nucleic acid sequence in a haploid genome. In other words, the candidate FISH probe will only bind to a nucleic acid sequence that occurs only once in the genomic region of interest. The candidate probe sequences are overlappingly tiled across a genomic region of interest. The candidate probe sequences are sorted from the smallest genomic distance to the largest genomic distance between neighboring overlapping tiled candidate FISH probe oligonucleotide sequences. A pair of neighboring candidate probes, that are closest together after being sorted, are evaluated for a probe property value. A first member of the pair with a more desirable probe property value is identified and the second pair member is removed from the plurality. For example, the probe property value may be GC content and a first member that has a higher GC content may be retained while the second pair member with the lower GC content is removed. In certain cases, a longer probe a probe with a higher GC content provides a brighter signal than a shorter probe with a lower GC content. In other embodiments, the probe property value may be selected from the group including, but not limited to: duplex melting temperature, hairpin stability, GC content, if the probe is within an exon, probe is within a gene, probe is within an intron and probe is within an intergenic region, proximity score, etc. The sorting, evaluating and removing steps described above repeated to produce a set of FISH probe oligonucleotide sequences.

In certain embodiments, the candidate FISH probe oligonucleotide sequences are in text format or as a string of text, where the text represents or corresponds to the sequence of nucleotides of the FISH probe oligonucleotide. The FISH probe oligonucleotide sequences can be of any length, e.g., from 50 to 300 nt, such as from 50 to 250 nt, and including from 100 nt to about 150 nt in length. In certain embodiments, the length of FISH probe oligonucleotide sequences is 150 nt. In certain embodiments, the length of FISH probe oligonucleotide sequences is 200 nt. However, oligonucleotide sequences of lesser or greater length may be used as appropriate.

The method of selecting FISH probes described herein may be viewed as an in silico method, i.e., the method may be performed by a computer specifically programmed to carry out the selection. The method finds use in identifying sequences for use in physical probes, e.g., in the form of surface-bound polynucleotides or in solution probes, with binding characteristics that make them suitable for use in genomic hybridization assays, such as, in situ hybridization assays.

In some cases, aspects of the subject method includes evaluating probe properties that can be determined a priori by the probe's sequence and the sequence of the genome it is contained within, and may further comprise expanding the set of properties from those that can be determined a priori, to those that can be measured empirically through experiments.

As noted above, aspects of the subject method includes providing a plurality of overlapping tiled candidate probe nucleic acid sequences for a genomic region of interest, where the genomic region of interest may be an entire genome of an organism or a portion of thereof, e.g., a chromosome or chromosomal fragment. In certain embodiments, the overlapping tiled candidate probe oligonucleotide sequences are initially identified by selecting sequences that comprehensively cover a whole chromosome, multiple chromosomes or a whole genome (e.g. the human genome), where the genomic sequence is searched when generating candidate probes. Such a method may include a homology search. In certain embodiments, known highly repetitive sequences can be removed by a process called RepeatMasking. Repeat-masked genomic sequences are publicly available on the web (e.g., UCSC's website having an address produced by placing “www.” before “genomebrowser.org”). In certain embodiments, a repeat masking tool called WindowMasker may be used to mask repetitive sequences. WindowMasker is well known in literature, for example, WindowMasker is described in Morgulis A., et al. (Bioinformatics. January 2006 15;22(2):134-41). In certain embodiments, the candidate sequences have been selected (i.e., designed) according to one or more particular parameters to be suitable for use in in situ hybridization, where representative parameters include, but are not limited to: length, melting temperature (Tm), non-homology with other regions of the genome, hybridization signal intensities, kinetic properties under hybridization conditions, etc., see e.g., U.S. Pat. No. 6,251,588, and Published United Sates Application No. 20040002070; the disclosures of which are herein incorporated by reference.

The number of tiled candidate FISH probe oligonucleotide sequences to be evaluated may be reduced upfront. This can be done on the basis of any known property of the probe, from thermodynamic properties, such as duplex-Tm and hairpin free energy, to percent GC content, to position on the genome, etc.

In certain examples, a candidate FISH probe is removed from the plurality of tiled candidate FISH probe oligonucleotide sequences if: (a) the candidate FISH probe sequence has a complementarity of 50% or more to a non-target region and/or (b) the candidate FISH probe is complementary (30%-100% complementarity) to more than fifty non-target regions. For example, if 100 nt of a candidate 150 mer FISH probe are complementary to a non-target region, the candidate probe is removed from the plurality of tiled candidate FISH probe oligonucleotide sequences. In another example, if 30 nt or more of a candidate 150 mer FISH probe are complementary to fifty or more non-target regions, the candidate probe is removed from the plurality of tiled candidate FISH probe oligonucleotide sequences. In yet other embodiments, only probes with a GC content in the range of 30% to 70% are evaluated. Thus, in certain embodiments, the plurality of tiled candidate FISH probe oligonucleotide sequences subjected to the steps of sorting, evaluating, removing, reiterating and outputting described above, are pre-selected based on any number of probe properties.

The number of initial candidate FISH probes that is generated may vary considerably. In certain embodiments the number is at least 10, at least 100, at least 1000, at least 10,000, at least 100,000, at least 1,000,000 or more, where in certain embodiments, 3 million or more, 5 million or more, 10 million or more, 20 or more, 50 million or more, 100 million or more, 300 million, 500 million or more, candidate probe sequences may be initially present in a given plurality of interest.

In certain embodiments, the initial tiled candidate FISH probes include overlapping probe sequences, such as, probe sequences tiled in 10 nt steps across a target region of a genome. For example, in embodiments where 150 nt long candidate FISH probes are generated, a pair of closest probes (in terms of genomic distance) may overlap by 140 nt. Tiled probes with more or less overlap may also be generated. The extent of overlap may be in the range of 2% to 95%; or 10% to 90%, or 20% to 80%, or 30% to 50%, for example.

In general terms, the subject method includes applying the pairwise selection described in U.S. Patent Application Publication No.: 2009/0036319 to evaluate a pair of neighboring probe sequences for a probe property and then scoring the neighboring probe sequences for the probe property, or properties, of interest. The pairwise filtering algorithm is a protocol of reducing the size of a set of candidate probe nucleic acid sequences (which may be referred to as an initial plurality) to a smaller set of probes, while enriching for a specific beneficial probe property or properties. The probe property may be selected from the group including, but not limited to: duplex melting temperature, hairpin stability, GC content, if the probe is within an exon, probe is within a gene, probe is within an intron and probe is within a intergenic region, proximity score (e.g., as described in U.S. application Ser. No. 11/888,038 filed on Jul. 30, 2007 titled “Methods and Systems for Evaluating CGH Candidate Probe Nucleic Acid Sequences,”), or any property or score for combined properties of the probe or the gene in which it is contained.

In certain cases, the probe property may be GC content. In certain embodiments, the probe in a pair of neighboring probe sequences that has the higher GC content will be retained while the probe with the lower GC content is removed from the plurality of candidate FISH probes. However, in embodiments where the initial plurality of candidate FISH probes are not pre-selected to have a GC content in the range of 30% to 70%, the probe in a pair of neighboring probe sequences that has the higher GC content will not be retained, if its GC content is more than 70%. In such embodiments, the probe in the pair of neighboring probe sequences that has the lower GC content will be retained. Similarly, if the probes in a pair of neighboring probe sequences have a GC content below 30%, the pair will be eliminated from the plurality of candidate FISH probes, for example.

In other embodiments, the method may include applying a biased pairwise probe filtering analysis to the candidate probes. Applying a biased pairwise selection algorithm includes, analyzing neighboring probe sequences within a genomic region of interest, evaluating the neighboring probe sequences for a first probe property or group of properties, evaluating the neighboring probe sequences for a second probe property or group of properties and scoring the neighboring probe sequences for the first probe property and weighting this scoring process by the presence or absence of the second probe property. When biased pairwise analysis is utilized, the probe properties of the first and second parameters may be selected from the group which includes, but is not limited to: duplex melting temperature, hairpin stability, GC content, probe is within an exon, probe is within a gene, probe is within an intron, probe is within an intergenic region, probe density for the target region, etc. Alternatively, the pairwise filtering selection algorithm may utilize a single score which combines multiple properties into a single value for each probe.

Biased pairwise filtering protocols find use in certain applications. For example, there may be reasons other than simple probe performance that drive the selection of probes. For example, it may be important to retain probes that overlap to a certain degree. An enrichment in the number of probes retained for each certain degree of overlap can be achieved by adding a biasing values to the scores upon which the probes are selected, hence trading of probe performance for desired content. This type of bias has the advantage of being quantitatively controllable. The larger the bias, the larger is the enrichment. For example, if the elimination of the less desirable probe would result in no overlapping probes being present for a certain region of the target sequence, this less desirable probe will not be eliminated. In some cases, if the closest pair of candidate probes overlap by 5 nt or less, then the pair is not subject to pairwise filtering and is retained in the final FISH probe oligonucleotide sequences. In other cases, if the closest pair of candidate probes overlap by 50 nt or less, then the pair is not subject to pairwise filtering and is retained in the final FISH probe oligonucleotide sequences. In certain embodiments, “locking” probes in place may be employed so that it can be assured that a certain probe or set thereof will persist through the pairwise reduction process and be included in the reduced set. This has the advantage of having those desired “locked probes” present during the uniform coverage procedure, rather than added to the plurality non-uniformly following the pairwise filtering. As such, embodiments of the invention include locking at least one member of the plurality so that it is present in said final collection. “Locking probes” might be positive control probes, for example.

Alternatively, applying pairwise selection analysis may comprise selecting a plurality of probe pairs, each probe pair comprising a first probe sequence and a second probe sequence which are adjacent probe sequences within the genomic region of interest, evaluating the first and second probe sequences for at least one probe property, assigning at least one score for each probe property to the first and second probe sequences, and determining which probe sequence of each probe pair comprises the optimum probe characteristics for use in a genomic hybridization assay, such as FISH assay. In some embodiments the probe pairs are randomly selected for pairwise analysis while in other embodiments the probe pairs are selected for pairwise analysis by the order in which they target the chromosome or gene sequence of interest. The order may be assigned in the 3′ to 5′ direction or 5′ to 3′ direction.

As such, embodiments of the pairwise filtering protocol of the invention include a step of providing a plurality of candidate probe nucleic acid sequences and then sorting the plurality of candidate probe nucleic acid sequences from smallest genomic distance to largest genomic distance between neighboring candidate probe nucleic acid sequences to produce a sorted plurality of candidate probe nucleic acid sequences. This plurality may be viewed as a distance sorted plurality and provides a list or arrangement of the constituent members of the plurality which is organized according to genomic distance (e.g., in terms of nucleotide residues) of the different members of the plurality. The distance sorted plurality provides information about the closest neighboring pairs on up to the most distant neighboring pairs from each other.

Following production of the sorted plurality, a probe property value for a neighboring pair of candidate probe nucleic acid sequences in the first sorted plurality is then assessed or evaluated, e.g., analyzed, to identify a first member of the neighboring pair with a more desirable probe property value for a given probe property than a second pair member of the neighboring pair. In certain embodiments, the neighboring pair that is evaluated is a pair of candidate probe nucleic acid sequences that is closest to each other in terms of genomic distance in the distance sorted plurality. The pair may be evaluated for the property value or values of interest using any convenient protocol, e.g., by comparing the values of each to each other and assigning a first member of the pair as having a value that is more desirable than a second member of the pair. Depending on the particular probe property or properties of interest, the member of the pair with the higher or lower value may be viewed as more desirable. For example, if a higher value for a probe property indicates a better probe, the member of the pair with the higher value will be identified as being more desirable than the second member of the pair.

Once the more desirable and less desirable members of the pair are identified, the member of the pair (e.g., the second member) that has the less desirable value is then removed, i.e., eliminated, from the plurality. As such, a new plurality which does not include the eliminated candidate probe nucleic acid is produced. Where desired, the method further includes maintaining a record of the order in which candidate probe nucleic acid sequence is removed from the plurality. For example, where the method includes producing pairwise elimination ranked record of a plurality of candidate probe nucleic acids, a record of when the candidate probe nucleic acid is removed from the plurality is made.

Following elimination of one of the members of the pair and prior to any further analysis of pairs in the plurality, the plurality less the first undesirable probe is resorted and then subjected to the pairwise analysis protocol as discussed above. Accordingly, the method includes reiterating the sorting, evaluating and removing steps at least once following removal of the first less desirable probe, where a number of desired iterations is made to produce a final collection of FISH probe oligonucleotide sequences.

As noted above, methods and algorithms for pairwise filtering has been described in U.S. Patent Application Publication No.: 2009/0036319 filed on Jul. 30, 2007 which is hereby incorporated by reference.

Pairwise filtering as described above provides a result, e.g., a set of FISH probe oligonucleotide sequences. The number of FISH probes that is selected may vary considerably. In certain embodiments the number is at least 10, at least 100, at least 1000, at least 10,000, at least 100,000, at least 1,000,000 or more, where in certain embodiments, 3 million or more, 5 million or more, 10 million or more, 20 or more, 50 million or more.

In certain embodiments, the resultant set(s) of FISH probe oligonucleotide sequences may be further filtered to remove probe sequences that have a certain undesirable probe property. For example, in embodiments where the initial plurality of candidate FISH probes are not pre-selected to have a GC content in the range of 30% to 70%, the GC content of FISH probes is assessed and probes not having a GC content in the range of 30% to 70% are eliminated. Similarly, FISH probes that would hybridize to a non-target sequence with a complementarity of 50% or more are eliminated. In certain embodiments, FISH probes that is complementary (30%-100% complementarity) to more than fifty non-target regions may be eliminated.

The result may take a variety of different formats, where the information content of the result may be simple or complex. For example, the information content of the result may simply be a list of identifiers of FISH probe nucleic acids that can be employed to obtain the actual sequences of the members in the filtered sets of nucleic acids. Alternatively, the information content of the result may provide additional information, such as the nucleotide sequences of member nucleic acids in the resultant filtered library.

The result is then output in some manner, where the outputting results in a physical transformation of matter physical transformation and/or a useful, concrete and tangible result. For example, the result may be made accessible to a user in some manner so as to make it a tangible result. The result may be made accessible in a number of different manners, such as by displaying it to a user, e.g., via a graphical user interface, by recording it onto a physical medium, e.g., a computer readable medium, and human readable medium, e.g., paper, etc. The above embodiments are merely exemplary.

In certain embodiments, the subject method is performed by a computer specifically programmed to carry out the subject method, for example, to perform steps (a) to (f) described above. For example, the subject method is performed by a computer that includes a processing module that carries out the subject method. In other words, the subject method is a computer-implemented method. In certain embodiments, the method is coded onto a computer-readable medium in the form of “programming”, where the term “computer storage readable medium” as used herein refers to any storage medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer.

A computer readable storage medium carrying one or more sequences of instructions is also provided. Execution of the one or more sequences of instructions by one or more processors causes the one or more processors to perform the steps of (a) sorting a plurality of tiled candidate FISH probe oligonucleotide sequences for a genomic region of interest from smallest genomic distance to largest genomic distance between neighboring candidate probe oligonucleotide sequences to produce a sorted plurality of tiled candidate FISH probe oligonucleotide sequences; (b) evaluating a probe property value for a neighboring pair of tiled candidate probe oligonucleotide sequences from the sorted plurality to identify a first member of the neighboring pair with a more desirable probe property value than a second pair member of the neighboring pair; (c) removing the second pair member from the plurality; and (d) reiterating the sorting, evaluating and removing steps at least once to produce a set of FISH probe oligonucleotide sequences. A “processor” references any hardware and/or software combination that will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

A system for implementing the subject method is also provided. In certain embodiments, the system includes (a) a communication module that includes an input manager for receiving a FISH probe request from a user and an output manager for communicating FISH probe oligonucleotide sequences to a user and (b) a processing module as described above. The request may vary in terms of content. For example, the request may include a simple number of desired probe sequences. Alternatively, the request may include biasing information, e.g., which probes are to be locked, etc. The system may be a computer-based system. A “computer-based system” refers to the hardware means, software means, and data storage means used to implement the subject method. The minimum hardware of the subject computer-based system includes a central processing unit (CPU), input means, output means, and data storage means.

The above described embodiments provide in silico filtered product sets or pluralities of candidate probe nucleic acid sequences. Resultant in silico sets of candidate probe nucleic acids of interest, e.g., those determined in the evaluation to be “satisfactory” may then be further empirically evaluated. In certain embodiments, empirical evaluation may include synthesizing the physical probes that include the FISH probe nucleic acid sequences of interest and assaying the probes in a hybridization assay. Such assays include assays in which the probes are screened according to at least one experimentally measurable parameter or property, the experimentally measurable property or parameter is selected from the group consisting of signal intensity, reproducibility of signal intensity, dye bias, susceptibility to non-specific binding, and persistence of probe hybridization.

In certain embodiments, the subject method includes a step of transmitting data or results that include the FISH probe oligonucleotide sequences or data generated using the probes in a FISH assay to a remote location. By “remote location” is meant a location other than the location at which the FISH probe oligonucleotide sequences are generated or where hybridization occurs. For example, a remote location could be another location (e.g. office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart.

In certain embodiments, the subject system may be viewed as being the physical embodiment of a web portal, where the term “web portal” refers to a web site or service, e.g., as may be viewed in the form of a web page, that offers a broad array of resources and services to users via an electronic communication element, e.g., via the Internet.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

### Compositions

Physical probes that include a set of FISH probe oligonucleotide sequences selected by the above described method and system are also provided. The physical probes may be provided as an oligonucleotide composition which may include the FISH probes in a solution, in a lyophilized form, in a pellet or on an array.

In certain embodiments, the composition may include a set of FISH probes that are at least 50 nt long, at least 100 nt long, or at least 150 nt long, or at least 200 nt long. In certain cases, the FISH probes may be up to 250 nt long, where a contiguous stretch of 150 nt are complementary to a nucleic acid sequence present in a genome of interest.

In some cases, the composition may include a set of FISH probes in which the individual members have a GC content in the range of 30% to 70%, or 35% to 70%, or 40% to 70%, or 30% to 60%, or 40% to 50%, etc.

In some cases, the composition may include a set of FISH probes, that when bound to the target region of the genome, overlap with the nearest neighboring probe. For example, a pair of neighboring FISH probes may overlap by at least about 50 nt, or at least about 40 nt, or at least about 30 nt, for example. In certain cases, the overlap may be 10 nt to 40 nt.

In addition, a composition may also contain one or more “singletons” i.e., at least one probe that binds to the same region as the set of overlapping probes, but does not overlap with other probes in the set.

There may be at least 10, at least 50, at least 100, at least 1,000, at least 5,000 up to 10,000 or 100,000 or more probes for a single genomic region, where up to 10%, up to 20%, up to 30%, up to 40%, up to 50%, up to 60%, up to 70% or up to 80% or 90% of the probes may be singletons and the remainder are overlapping.

In some cases, the composition may include a set of FISH probes where each probe in the set only binds to a single site in a haploid genome. As noted above, the sequence specificity of the probe may be determined empirically or experimentally or both.

In certain embodiments, the composition may include a set of FISH probes of the formula X₁—V—X₂ (from 5′ to 3′), where X₁ and X₂ provide binding sites for a pair of PCR primers (e.g., where X₁ has the same sequence as a first PCR primer and X₂ has a sequence that is complementary to a second PCR primer), and V is a variable region that has a nucleotide sequence selected by the above described method. The variable region may be amplified by the pair of PCR primers. The primer binding sites may be 15-40 (e.g., 18 to 30) nucleotides in length, and the variable region (having the FISH probe oligonucleotide sequence selected by the subject method) may be in the range of 90 to 180 (e.g., 100-150) nucleotides in length, although primer binding sites and variable regions outside of these ranges are envisioned. As noted above, the variable regions may overlap with the variable regions of other probes. In general, the extent of overlap may be anywhere from 2% to 95% overlap (e.g., 20% to 80% overlap). In certain cases, the FISH probe oligonucleotide sequence selected by the subject method are not uniquely tiled (e.g. end-to-end tiling). In some cases, X₁ and X₂ sequences may be selected such that only certain probes are amplified by a PCR primer pair. Thus, only FISH probes specific to chromosome 1 may be amplified from a set of FISH probes for chromosomes 1 to 5, for example.

In certain embodiments, the composition of FISH probes is provided on an array. In certain embodiments, the array may be synthesized using in situ synthesis methods in which nucleotide monomers are sequentially added to a growing nucleotide chain that is attached to a solid support in the form of an array. Such in situ fabrication methods include those described in U.S. Pat. Nos. 5,449,754 and 6,180,351 as well as published PCT application no. WO 98/41531, the references cited therein, and in a variety of other publications. In one embodiment, the oligonucleotide composition may be made by fabricating an array of the oligonucleotides using in situ synthesis methods, and cleaving oligonucleotides from the array.

The composition may include at least 10, at least 100, at least 1000, at least 10,000, at least 100,000, at least 1,000,000 or more, where in certain embodiments, 3 million or more, 5 million or more, 10 million or more, 20 or more, 50 million or more FISH probes.

### Method for Sample Analysis

Physical FISH probes that include FISH probe oligonucleotide sequences may be used to perform in situ hybridization. The physical FISH probes may be labeled by a number of labeling methods well known in the art. For example, the label may be simultaneously incorporated during the amplification of the probe. Thus, for example, polymerase chain reaction (PCR) with labeled primers or labeled nucleotides will provide a labeled amplification product. In certain embodiments, a label may be added directly to the amplification products. Means of attaching labels to nucleic acids are well known to those of skill in the art and include, for example nick translation or end-labeling, by kinasing of the nucleic acid and subsequent attachment of a nucleic acid linker joining the oligonucleotides to a label. In certain embodiments, the FISH probes may be labeled by Universal Linkage System (ULS™, KREATECH Diagnostics). In brief, ULS™ labeling is based on the stable binding properties of platinum (II) to nucleic acids. The ULS molecule consists of a monofunctional platinum complex coupled to a detectable molecule of choice. Standard methods may be used for labeling the oligonucleotide, for example, as set out in Ausubel, et al, (Short Protocols in Molecular Biology, 3rd ed., Wiley & Sons, 1995) and Sambrook, et al, (Molecular Cloning: A Laboratory Manual, Third Edition, (2001) Cold Spring Harbor, N.Y.).

In general terms, once labeled, the amplification products are hybridized to a sample containing intact chromosomes, and the binding is analyzed. For example, an interphase or metaphase chromosome preparation may be produced. The chromosomes are attached to a substrate, e.g., glass, contacted with the probe and incubated under hybridization conditions. Wash steps remove all unhybridized or partially-hybridized probes, and the results are visualized and quantified using a microscope that is capable of exciting the dye and recording images.

Such methods are generally known in the art and may be readily adapted for use herein. For example, the following references discuss chromosome hybridization: Ried et al., Human Molecular Genetics, Vol 7, 1619-1626; Speicher et al, Nature Genetics, 12, 368-376, 1996; Schröck et al., Science, 494-497, 1996; Griffin et al., Cytogenet Genome Res. 2007;118(2-4):148-56; Peschka et al., Prenat Diagn., December 1999;19(12):1143-9; Hilgenfeld et al, Curr Top Microbiol Immunol., 1999, 246: 169-74.

Accordingly, some of the features and advantages of certain embodiments of the subject method include: 1) avoidance of non-specific amplification of starting materials, which leads to random amplification bias; 2) consistent creation of probes of a designated length (fragments generated in current PCR processes are often too long to be used effectively in FISH, requiring partial digestion by restriction enzymes that are difficult to control); 3) targeted chromosome labeling on a very fine level such that microduplications, microinversions and microdeletions can be detected; and 4) utilization of standard laboratory equipment for the visual detection of signals.

Prior to in situ hybridization, the FISH probes may be denatured. Denaturation is typically performed by incubating in the presence of high pH, heat (e.g., temperatures from about 70° C. to about 95° C.), organic solvents such as formamide and tetraalkylammonium halides, or combinations thereof.

Intact chromosomes are contacted with labeled probes under in situ hybridizing conditions. “In situ hybridizing conditions” are conditions that facilitate annealing between a nucleic aid and the complementary nucleic acid in the intact chromosomes. Hybridization conditions vary, depending on the concentrations, base compositions, complexities, and lengths of the probes, as well as salt concentrations, temperatures, and length of incubation. For example, in situ hybridizations may be performed in hybridization buffer containing 1×-2×SSC, 50% formamide, and blocking DNA to suppress non-specific hybridization. In general, hybridization conditions include temperatures of about 25° C. to about 55° C., and incubation times of about 0.5 hours to about 96 hours. Suitable hybridization conditions for a set of oligonucleotides and chromosomal target can be determined via experimentation which is routine for one of skill in the art.

Fluorescence of a hybridized chromosome can be evaluated using a fluorescent microscope. In general, excitation radiation, from an excitation source having a first wavelength, passes through excitation optics. The excitation optics causes the excitation radiation to excite the sample. In response, fluorescent molecules in the sample emit radiation that has a wavelength that is different from the excitation wavelength. Collection optics then collects the emission from the sample. The computer also can transform the data collected during the assay into another format for presentation. In general, known robotic systems and components can be used.

In certain embodiments, the signal from the binding of the labeled probe to a chromosome may be compared with that of a reference chromosome. The reference chromosome may be from a healthy or wild-type organism. Briefly, the method comprises contacting under in situ hybridization conditions a test chromosome from the cellular sample with a plurality of fluorescently-labeled FISH probes generated by the subject method and contacting under in situ hybridization conditions a reference chromosome with the same plurality of fluorescently-labeled FISH probes. After hybridization, the emission spectra created from the unique binding patterns from the test chromosome are compared against those of the reference chromosome.

Thus, the structure of a test chromosome may be determined by comparing the pattern of binding of the labeled FISH probes to the test chromosome with the binding pattern of the same labeled FISH probes with a reference chromosome. The binding pattern of the reference chromosome may be determined before, after or at the same time as the binding pattern for the test chromosome. This determination may be carried out either manually or in an automated system. The binding pattern associated with the test chromosome can be compared to the binding pattern that would be expect for known deletions, insertions, translocation, fragile sites and other more complex rearrangements, and/or refined breakpoints. The matching may be performed by using computer-based analysis software known in the art. Determination of identity may be done manually (e.g., by viewing the data and comparing the signatures by hand), automatically (e.g., by employing data analysis software configured specifically to match optically detectable signature), or a combination thereof.

In another embodiment, the test sample is from an organism suspected to have cancer and the reference sample may comprise a negative control (non-cancerous) representing wild-type genomes and second test sample (or a positive control) representing a cancer associated with a known chromosomal rearrangement. In this embodiment, comparison of all these samples with each other using the subject method may reveal not only if the test sample yields a result that is different from the wild-type genome but also if the test sample may have the same or similar genomic rearrangements as another cancer test sample.

### Utility

The subject method, system and composition find use in a myriad of nucleic acid sequence detection applications of interest, such as, genome mapping, diagnosis, or investigation of various types of genetic abnormalities, cancer or other diseases, including but not limited to, leukemia; breast carcinoma; prostate cancer; Alzheimer's disease; Parkinson's disease; epilepsy; amyotrophic lateral sclerosis; multiple sclerosis; stroke; autism; Cri du chat (truncation on the short arm on chromosome 5), 1p36 deletion syndrome (loss of part of the short arm of chromosome 1), Angelman syndrome (loss of part of the long arm of chromosome 15); Prader-Willi syndrome (loss of part of the short arm of chromosome 15); acute lymphoblastic leukemia and more specifically, chronic myelogenous leukemia (translocation between chromosomes 9 and 22); Velocardiofacial syndrome (loss of part of the long arm of chromosome 22); Turner syndrome (single X chromosome); Klinefelter syndrome (an extra X chromosome); Edwards syndrome (trisomy of chromosome 18); Down syndrome (trisomy of chromosome 21); Patau syndrome (trisomy of chromosome 13); and trisomies 8, 9 and 16, which generally do not survive to birth.

The disease may be genetically inherited (germline mutation) or sporadic (somatic mutation). Many exemplary chromosomal rearrangements discussed herein are associated with and are thought to be a factor in producing these disorders. Knowing the type and the location of the chromosomal rearrangement may greatly aid the diagnosis, prognosis, and understanding of various mammalian diseases.

Certain of the above-described methods can also be used to detect diseased cells more easily than standard cytogenetic methods. The above-described methods do not require living cells and can be quantified automatically since a computer can be programmed to count the number and/or arrangement of fluorescent dots present.

### EXAMPLES

### Example 1

### Generation of FISH Probes for Human Chromosome 1

The optimal probe length and the optimal degree of overlap between two probes adjacent to each other in terms of genomic distance were determined experimentally. 150 nt long candidate FISH probe oligonucleotide sequences were tiled in 10 nt steps across the non-repeat masked sequences of the human genome (UCSC genome build hg18). The pairwise probe selection algorithm was used as described above. Briefly, a pair of probes, closest together in terms of genomic distance, was compared for GC content and the probe with the lower GC content was eliminated. The spacing between the probes was reevaluated and another round of evaluating was done. The selection process was biased for selecting probes that are separated by no more than a genomic distance of 50 nt. In other words, if after one or more iterations of the algorithm, the probes closest together were separated by 50 nt, then the pair was retained. The selection process was repeated till the target number of probes were selected, i.e., probes arranged at genomic distance of 50 nt. Thus, these probes overlap by 100 nt with their nearest neighbor. The selection process resulted in 21.9 million FISH probes. These 21.9 million FISH probes were analyzed by BLAST against the human genome and GC content. FISH probes that were complementary to non-target regions (more than 50% complementarity) and FISH probes that were complementary (20%-100% complementarity) to more than fifty non-target regions were removed. FISH probes with GC content outside of 30% to 70% were also removed. For chromosome 1, these selection criteria yielded probes with 50 nt median spacing, 145 nt mean spacing, and 42.4% GC content.

### Example 2

### Generation of FISH Probes for Unmapped Human Sequences

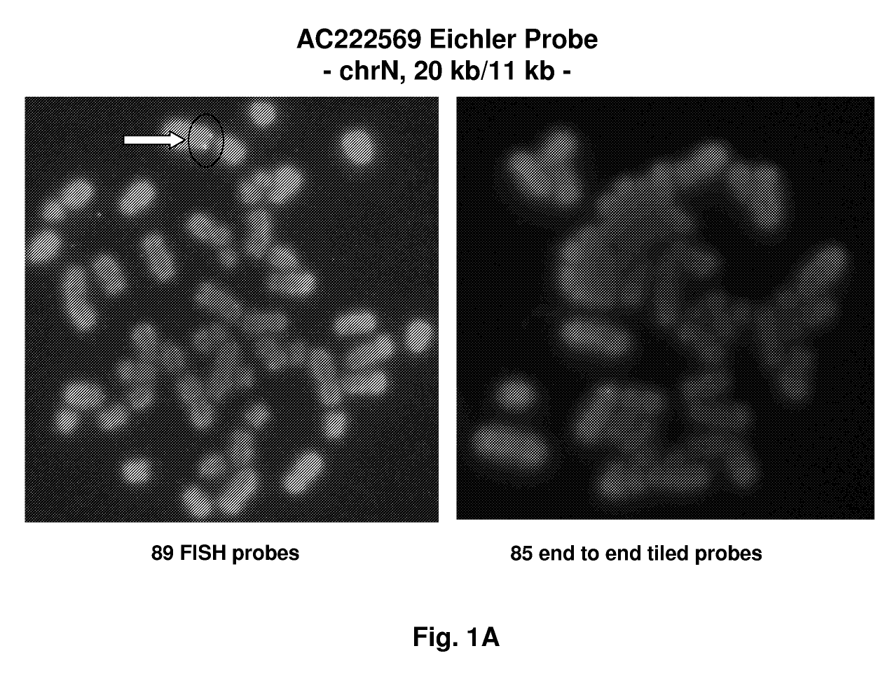

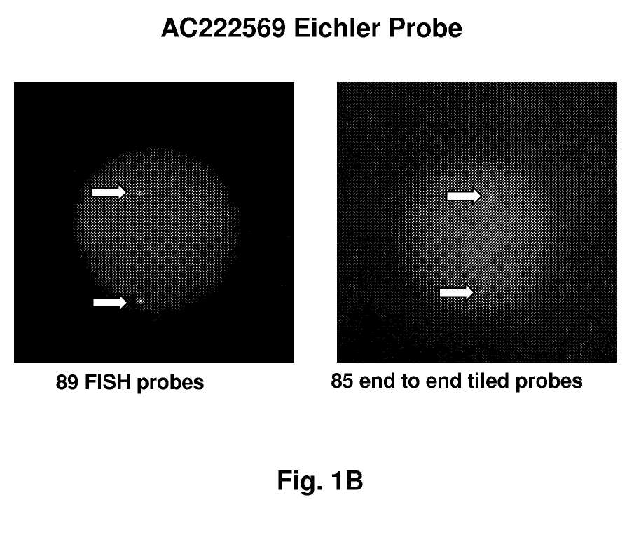

Candidate FISH probe oligonucleotide sequences for mapping a 11 kb region of the human genome were generated and 89 FISH probe oligonucleotide sequences were selected as described in Example 1. These 89 FISH probes were synthesized and fluorescently labeled. For comparison, 85 end-to-end tiled probes were generated for the 11 kb region of the human genome by standard tiling. Fluorescently labeled end-to-end tiled probes and FISH probes were hybridized to human chromosomes. The experimental workflow was identical for end-to-end tiled probes and FISH probes and the experiments were conducted simultaneously. The 11 kb region was successfully mapped using the FISH probes (while the end-to-end tiled probes did not show any significant binding. See FIG. 1A, left panel, arrow pointing to the encircled signal from FISH probes and FIG. 1A, right panel, showing no signal from end-to-end tiled probes.

The same sets of probes were used to hybridize to chromosome in cells at interphase. The FISH probes provided a brighter signal than the end-to-end tiled probes (FIG. 1B, signal marked with arrows).

### Example 3

### Generation of FISH Probes for Repeat Rich Genomic Region

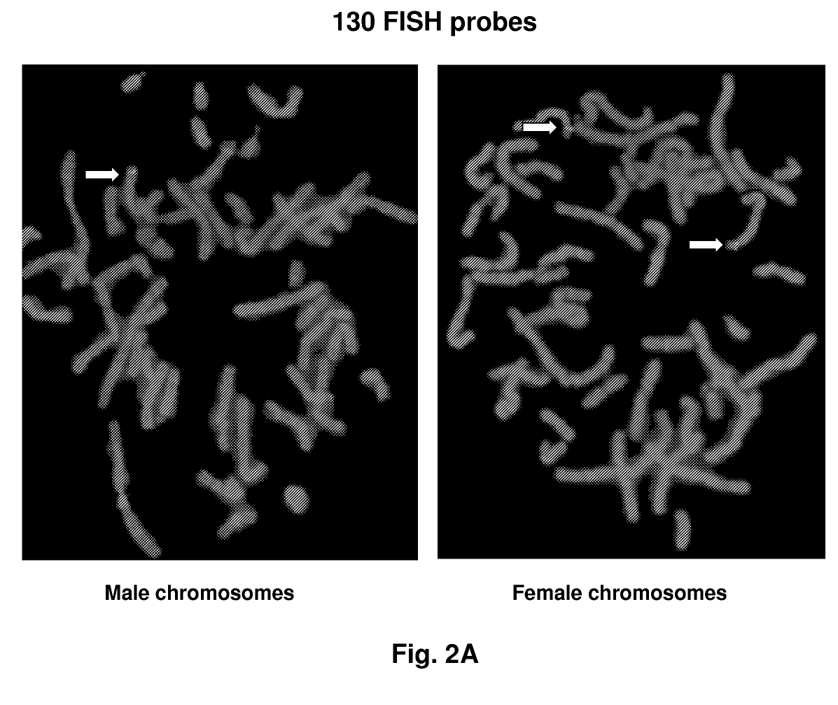

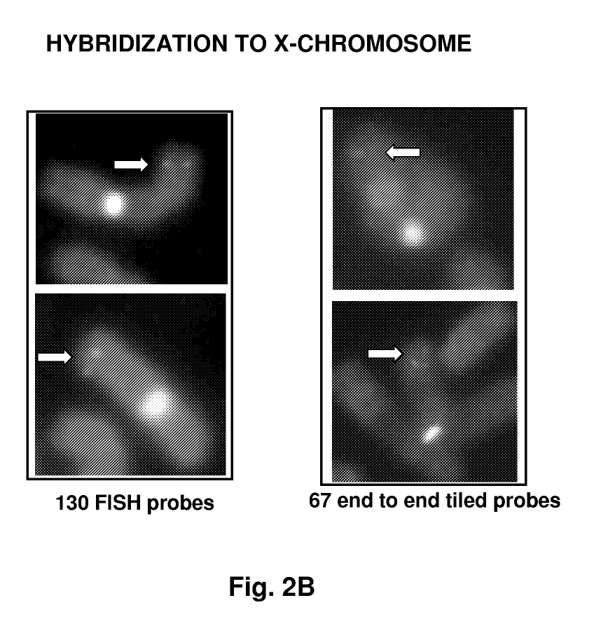

A 31 kb region in a repeat rich region of chromosome X was visualized using FISH probes selected as described in example 1 as well as with end-to-end tiled probes. 130 FISH probes and 67 end-to-end tiled probes were fluorescently labeled and hybridized to human chromosomes. FIG. 2A depicts labeling of male and female chromosomes with the FISH probes. The hybridization of end-to end tiled probes to male and female chromosomes did not yield a detectable signal (data not shown).

A repeat of the experiment yielded a faint signal when end-to end tiled probes were used (FIG. 2B, right panels), but the signal from hybridization of FISH probes was significantly better (FIG. 2B, left panels).

### Example 4

### Effect of Reduction in the Number of FISH Probes

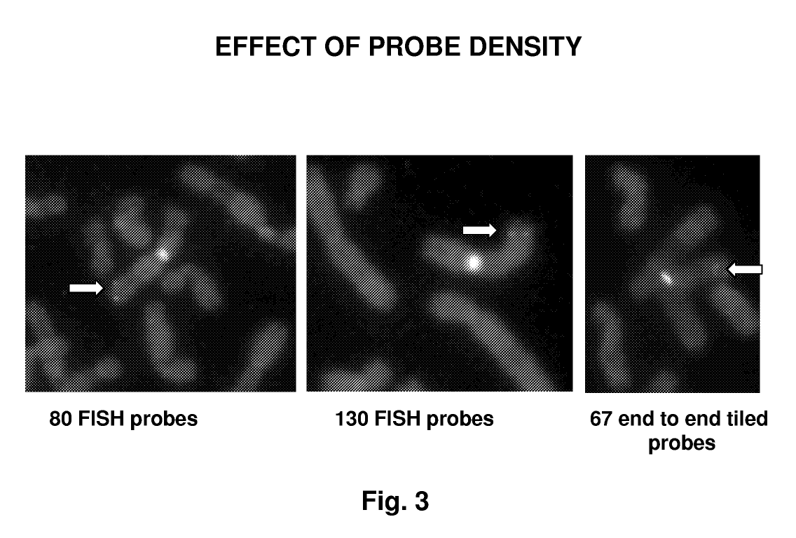

To demonstrate that the difference in signal intensity between the FISH probes and the end-to-end tiled probes did not come from the higher number of FISH probes available for hybridization to a target region, probes were randomly removed from the initial 130 FISH probes of example 3 to generate a probe set with 80 FISH probes. Even with the decreased number of FISH probe, the FISH probes showed a significantly brighter signal as compared to that seen with end-to end tiled probes (FIG. 3). See FIG. 3, left panel, the arrow marks the signal from 80 FISH probes; middle panel, the arrow marks the signal from 130 FISH probes; and right panel, the arrow marks the signal from 67 end-to-end tiled probes.

What is claimed is:

1. A method comprising:
(a) providing a plurality of overlapping tiled candidate fluorescence in situ hybridization (FISH) probe oligonucleotide sequences, wherein said overlapping tiled candidate FISH probe oligonucleotide sequences are complementary to non-repeat sequences of a genome of interest and are preselected based on at least one probe property;
(b) sorting said plurality of overlapping tiled candidate FISH probe oligonucleotide sequences from smallest genomic distance to largest genomic distance between neighboring overlapping tiled candidate FISH probe oligonucleotide sequences to produce a sorted plurality of overlapping tiled candidate FISH probe oligonucleotide sequences;
(c) evaluating a probe property value for a neighboring pair of overlapping tiled candidate FISH probe oligonucleotide sequences from said sorted plurality to identify a first member of said neighboring pair with a more desirable probe property value than a second pair member of said neighboring pair;
(d) removing said second pair member from said plurality;
(e) reiterating said sorting, evaluating and removing steps at least once to produce a set of FISH probe oligonucleotide sequences; and
(f) outputting said set of FISH probe oligonucleotide sequences.

2. The method of claim 1, wherein said probe property value is determined by a computer.

3. The method of claim 2, wherein said probe property is selected from the group consisting of duplex melting temperature, hairpin stability, GC content, probe complementary to an exon, probe complementary to a gene, probe complementary to intron, probe complementary to multiple regions in said genome and a proximity score.

4. The method of claim 3, wherein said probe property value comprises GC content and said first member has a higher GC content than said second member.

5. The method of claim 1, wherein said neighboring pair evaluated in step (c) is a pair that is closest to each other in terms of genomic distance in said sorted plurality.

6. The method of claim 1, wherein said plurality of overlapping tiled candidate FISH probe oligonucleotide sequences have GC content in the range of 30% to 70%.

7. The method of claim 1, wherein said set of FISH probes have GC content in the range of 30% to 70%.

8. The method of claim 1, wherein said plurality of overlapping tiled candidate FISH probe oligonucleotide sequences are at least 100 nucleotides long.

9. The method of claim 5, wherein said method comprises recalculating genomic distances following each removal of a tiled candidate probe oligonucleotide sequence from said plurality.

10. The method of claim 1, wherein said outputting comprises recording information to a physical medium or displaying said FISH probe oligonucleotide sequences on a computer monitor.

11. The method of claim 1, wherein said method further comprises producing a set of FISH probe oligonucleotides comprising said set of FISH probe oligonucleotide sequences.

12. The method of claim 11, wherein said method further comprises assaying said FISH probe oligonucleotide, wherein said assaying comprises: (a) labeling said set of FISH probe oligonucleotides to produce a set of labeled FISH probe oligonucleotides and (b) hybridizing said set of labeled FISH probe oligonucleotides to an intact chromosome.

13. The method of claim 1, wherein said method further comprises fabricating an array that comprises FISH probe oligonucleotides comprising said FISH probe oligonucleotide sequences.

14. The method of claim 13, further comprising assaying said FISH probe oligonucleotides, wherein said assaying comprises: (a) labeling said set of FISH probe oligonucleotides to produce a set of labeled FISH probe oligonucleotides and (b) hybridizing said set of labeled FISH probe oligonucleotides to an intact chromosome.

15. The method of claim 1, wherein said plurality of overlapping tiled candidate FISH probe oligonucleotide sequences comprises more than one hundred million candidate FISH probe oligonucleotide sequences.

16. The method of claim 1, wherein said set of FISH probe oligonucleotide sequences comprises more than ten million FISH probe oligonucleotide sequences.

17. A computer readable medium carrying one or more sequences of instructions, wherein execution of one or more sequences of instructions by one or more processors causes the one or more processors to perform the steps of:
(a) sorting a plurality of overlapping tiled candidate FISH probe oligonucleotide sequences for a genomic region of interest from smallest genomic distance to largest genomic distance between neighboring candidate probe oligonucleotide sequences to produce a sorted plurality of overlapping tiled candidate FISH probe oligonucleotide sequences;
(b) evaluating a probe property value for a neighboring pair of overlapping tiled candidate probe oligonucleotide sequences from said sorted plurality to identify a first member of said neighboring pair with a more desirable probe property value than a second pair member of said neighboring pair;
(c) removing said second pair member from said plurality; and
(d) reiterating said sorting, evaluating and removing steps at least once to produce a set of FISH probe oligonucleotide sequences.

18. A system comprising:
(a) a communication module comprising an input manager for receiving a request for a set of FISH probe oligonucleotide sequences from a user and an output manager for communicating the set of FISH probe oligonucleotide sequences to a user;
(b) a processing module comprising one or more sequences of instructions configured to:
(i) sort a plurality of overlapping tiled candidate FISH probe oligonucleotide sequences for a genomic region of interest from smallest genomic distance to largest genomic distance between neighboring candidate probe oligonucleotide sequences to produce a sorted plurality of overlapping tiled candidate FISH probe oligonucleotide sequences;
(ii) evaluating a probe property value for a neighboring pair of candidate FISH probe oligonucleotide sequences from said sorted plurality to identify a first member of said neighboring pair with a more desirable probe property value than a second pair member of said neighboring pair;
(iii) removing said second pair member from said plurality;
(iv) reiterating said sorting, evaluating and removing steps at least once to produce the set of FISH probe nucleic acid sequences.

19. A method of selecting a set of FISH probe oligonucleotide sequences from a plurality of overlapping tiled candidate FISH probe oligonucleotide for a genomic region of interest, said method comprising:
(a) inputting a request for FISH probe for a genomic region of interest into a system comprising a processing module comprising one or more sequences of instructions configured to:
(i) sort a plurality of overlapping tiled candidate FISH probe oligonucleotide sequences for a genomic region of interest from smallest genomic distance to largest genomic distance between neighboring candidate probe nucleic acid sequences to produce a sorted plurality of overlapping tiled candidate FISH probe oligonucleotide sequences;
(ii) evaluating a probe property value for a neighboring pair of candidate FISH probe oligonucleotide sequences from said sorted plurality to identify a first member of said neighboring pair with a more desirable probe property value than a second pair member of said neighboring pair;
(iii) removing said second pair member from said plurality;
(iv) reiterating said sorting, evaluating and removing steps at least once to produce a set of FISH probe oligonucleotide sequences; and
(b) receiving from said system an output comprising a subset of said plurality that has been selected from said record to match said request.

20. The method according to claim 19, wherein said request comprises a desired number of FISH probes for a given genomic region.
